(19) United States
(12) Patent Application Publication
(10) Pub. No.: US 2013/0175963 A1
(43) Pub. Date: Jul. 11, 2013

(54) MOTOR CONTROL APPARATUS

(71) Applicant: DENSO CORPORATION, Kariya-city (JP)

(72) Inventor: Jun Yamada, Nagoya-city (JP)

(73) Assignee: DENSO CORPORATION, Kariya-city (JP)

(21) Appl. No.: 13/709,259

(22) Filed: Dec. 10, 2012

(30) Foreign Application Priority Data
Jan. 10, 2012 (JP) 2012-2621

(51) Int. Cl. H02P 3/08

(52) U.S. Cl. CPC H02P 3/08
USPC 318/468

(57) ABSTRACT

A motor control apparatus that controls a motor which switches an operating position of a control object and that is powered from a power source through a switching portion which is turned on or off by an operating portion includes a control portion executing a return control after an abutment control. The control portion maintains the switching portion on until the return control is completed so as to continue powered from the power source, when the operating portion is operated to turn the switching portion off in a time period from when the abutment control is started to when the return control is completed.

### CROSS REFERENCE TO RELATED APPLICATION

This application is based on Japanese Patent Application No. 2012-2621 filed on Jan. 10, 2012, the disclosure of which is incorporated herein by reference in its entirety.

### TECHNICAL FIELD

The present disclosure relates to a motor control apparatus.

### BACKGROUND

Recently, a mechanical drive system is replaced with an electrical drive system in a vehicle to save a space, to ease a construction and to improve a controllability. JP-2004-308846A (US 2004/0200301 A1) describes a system in which a range change mechanism of an automatic transmission is driven by a motor in a vehicle. In this system, a rotational shaft of the motor is coupled to an output shaft which drives the range change mechanism via a speed reducing mechanism, so that a range of the automatic transmission can be changed. An encoder synchronizing with a rotation of the motor is provided in the system to output a pulse per predetermined angle. The rotational shaft of the motor is rotated to a target position (target count value) corresponding to a target range based on a count value of the pulse, so that the range change mechanism is changed to have the target range.

A rotational amount (rotational angle) of the motor is converted to a rotational amount (rotational angle) of a control object, which is controlled by the motor, via a rotational transmission system. A play may be generated between members of the rotational transmission system. For example, a play (backlash) may be generated between gear wheels of a speed reducing mechanism. Further, it is necessary to provide a clearance for easily fitting a connecting portion of a rotational shaft of the speed reducing mechanism to an engaging hole of a connecting shaft of the control object. The connecting portion is provided at a distal end portion of the rotational shaft and a cross-section of the connecting portion is a noncircle-shape such as a square-shape or a D-shape. In this case, even though the rotational angle of the motor is controlled with accuracy based on the count value of the pulse of the encoder, an error corresponding to the play of rotational transmission system is generated in the rotational angle of the control object (operating amount of the range change mechanism), and thereby it is difficult to control the operation amount of the range change mechanism with accuracy.

An abutment control is operated in which the motor is rotated until abutting against a limit position (wall) of a moveable range of the range change mechanism. The limit position is learned as a standard position. The rotational amount of the motor is controlled based on the standard position. When the motor is rotated in one direction by the abutment control, a detent spring, which is a relatively weak part of the rotational transmission system in stiffness, is bent and deformed by a torque of the motor, and thereby an elastic repulsion is generated. In a case where the motor is stopped at the limit position, when the torque of the motor is disappeared, the motor is returned by the elastic repulsion. Thus, it is likely that a shift range may be switched to a non-intended range by the elastic repulsion.

As a solution of the above issue, a return control is operated in which the rotational position of the motor is returned by a predetermined amount to cancel the deformation in the detent spring by rotating the motor in an opposite direction opposite from the one direction in the abutment control after executing the abutment control.

Usually, the motor is operated continuously from the time the abutment control is started to the time the return control is completed. However, if a driver of the vehicle turns an ignition switch (power source operating switch) off in the abutment control or the return control, a power supply to the motor control apparatus is shut down. In this case, the drive operation of the motor is terminated so that the elastic repulsion may still exist in the abutment control or the return control. Thus, it is likely that the shift range may be switched to a non-intended range by the elastic repulsion.

### SUMMARY

According to an aspect of the present disclosure, a motor control apparatus that controls a motor which switches an operating position of a control object and that is powered from a power source through a switching portion which is turned on or off by an operating portion includes a control portion. The control portion executes a return control after an abutment control. The abutment control for sensing a standard position of the motor is executed by rotating the motor in one direction until the control object is abutted against a limit position of a moveable range of the control object. The return control is executed by rotating the motor in an opposite direction opposite from the one direction to return a rotational position of the motor by a predetermined amount. The control portion maintains the switching portion on until the return control is completed so as to continue powered from the power source, when the operating portion is operated to turn the switching portion off in a time period from the time the abutment control is started to the time the return control is completed.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a perspective view illustrating an outline of a range change apparatus according an embodiment of the present disclosure;

FIG. 2 is a schematic view illustrating a configuration of a control system of the range change apparatus according to the embodiment;

FIG. 3 is a graph illustrating a relationship between a P-range holding recess of a detent lever, a Non-P-range holding recess of a detent lever, and an engaging portion of a detent spring, according to the embodiment;

FIG. 4 is a time chart illustrating a comparison between the embodiment and a conventional example, when an ignition switch is turned off in a return control; and

FIG. 5 is a flowchart illustrating a procedure of a power switch control program according to the embodiment.

### DETAILED DESCRIPTION

An embodiment will be described with reference to the accompanying drawings, in which a motor control apparatus of the present disclosure is applied to a range change apparatus of an automatic transmission for a vehicle.

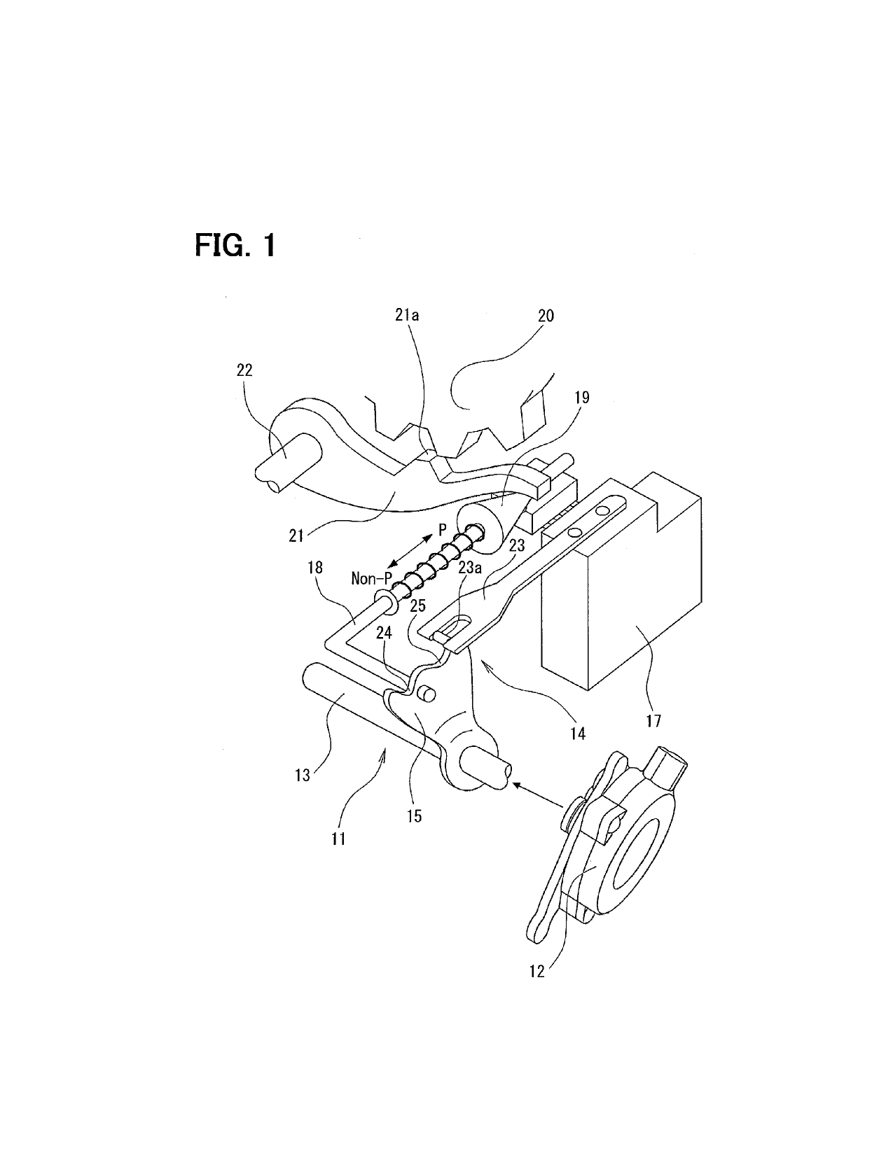

First, a structure of a range change mechanism 11 will be schematically described with reference to FIG. 1.

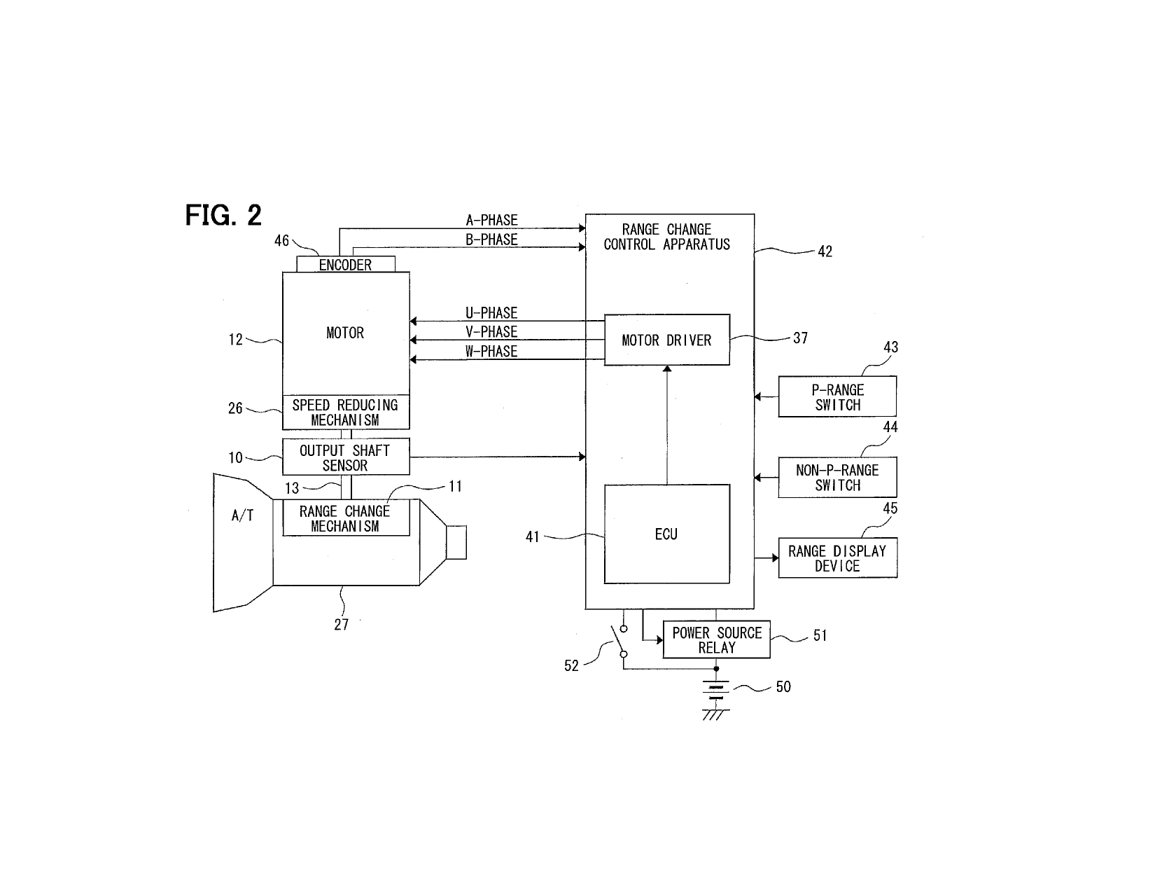

An electric motor 12, which serves as a drive source of the range change mechanism 11, may be, for example, a switched reluctance motor (SR motor). The motor 12 includes a speed reducing mechanism 26 (see FIG. 2), which reduces a rotational speed of a rotor of the motor 12. Furthermore, an output shaft sensor 10 is provided to the motor 12 to sense a rotational position of an output shaft 13 of the motor 12. A detent lever 15 is fixed to the output shaft 13.

A parking rod 18, which is configured into an L-shape, is fixed to the detent lever 15. A conical body 19, which is provided at a distal end portion of the parking rod 18, contacts a lock lever 21. The lock lever 21 is pivoted upward or downward about a shaft 22 depending on a position of the conical body 19 to lock or unlock a parking gear 20. The parking gear 20 is provided to an output shaft of an automatic transmission 27. When the parking gear 20 is locked by the lock lever 21, a driving wheel of the vehicle is held in a non-rotatable state (a parking state).

A detent spring 23 is fixed to a support base 17 to hold the detent lever 15 to a parking range (hereinafter, referred to as a P-range) as well as to another range (hereinafter, referred to as a Non-P-range). When an engaging portion 23a, which is provided to a distal end of the detent spring 23, is fitted into a P-range holding recess 24 of the detent lever 15, the detent lever 15 is held in a position of the P-range. Alternatively, when the engaging portion 23a of the detent spring 23 is fitted into a Non-P-range holding recess 25 of the detent lever 15, the detent lever 15 is held in a position of the Non-P-range. A detect mechanism 14 is defined by the detent lever 15 and the detent spring 23, and maintains the rotational position of the detent lever 15 at each range position.

In the P-range, the parking rod 18 is moved toward the lock lever 21, so that a large diameter portion of the conical body 19 pushes the lock lever 21 upward. Thereby, a protrusion 21a of the lock lever 21 is received in the parking gear 20 to lock the parking gear 20. In this way, the output shaft of the automatic transmission 27 (the drive wheel) is placed in the locked state (the parking state).

In the Non-P-range, the parking rod 18 is moved in a direction away from the lock lever 21. Thereby, the large diameter portion of the conical body 19 is removed from the lock lever 21, so that the lock lever 21 is pivoted downward. In this way, the protrusion 21a of the lock lever 21 is released from the parking gear 20 to unlock the parking gear 20. Therefore, the output shaft of the automatic transmission 27 is held in the rotatable state (drivable state of the vehicle).

The output shaft sensor 10 is a rotation sensor (e.g., a potentiometer), which outputs a voltage that corresponds to a rotational angle of the output shaft 13 of the speed reducing mechanism 26 of the motor 12. Based on the output voltage of the output shaft sensor 10, it is possible to determine which one of the P-range and the Non-P-range is the current range.

The motor 12 further includes an encoder 46 to sense a rotational angle (rotational position) of the rotor. The encoder 46 may be, for example, a magnetic rotary encoder. The encoder 46 is provided to synchronize with a rotation of the rotor of the motor 12 so that the encoder 46 outputs a pulse signal of an A-phase (A-phase signal) and a pulse signal of a B-phase (B-phase signal) to a range change control apparatus 42 (motor control apparatus) per predetermined angle. An electronic control unit (ECU) 41 of the range change control apparatus 42 counts the A-phase signal and the B-phase signal outputted by the encoder 46, more specifically, counts the rising edges and falling edges of the A-phase signal and the rising edges and falling edges of the B-phase signal. Based on the count value of the encoder 46 (encoder count value), the ECU 41 drives the motor 12 by using a motor driver 37 to switch an exciting phase of the motor 12 in a predetermined order. Further, two combinations of both windings of three phases (U-phase, V-phase, W-phase) of the motor 12 and the motor driver 37 may be provided such that even though one combination is failure, the other combination can drive the motor 12.

During a rotation of the motor 12, the rotational direction of the motor 12 of the motor 12 is determined based on the generating order of the A-phase and B-phase signals (i.e., based on which one of the A-phase signal and the B-phase signal is generated first). In the case of the normal rotation (i.e., the rotational direction from the P-range to the Non-P-range), the encoder count value is counted up. On the other hand, in the case of the reverse rotation (i.e., the rotational direction from the Non-P-range to the P-range), the encoder count value is counted down.

In this way, even when the motor 12 is rotated in any one of the normal rotational direction and the reverse rotational direction, the relationship between the encoder count value and the rotational position of the motor 12 is maintained. Thus, even when the motor 12 is rotated in any one of the normal rotational direction and the reverse rotational direction, the rotational position of the motor 12 can be sensed based on the encoder count value. Then, based on the sensed rotational position of the motor 12, the winding, which correspond to the sensed rotational position of the motor 12, is energized to rotate the motor 12.

An operational signal of a P-range switch 43, which is manipulated to change the range to the P-range, and an operational signal of a Non-P-range switch 44, which is manipulated to change the range to the Non-P-range, are supplied to the range change control apparatus 42. The selected range, which is selected by the manipulation of the P-range switch 43 or the Non-P-range switch 44, is displayed on a range display device 45 that is provided to an instrument panel (not shown), after a shift range is switched by the motor 12.

The range change control apparatus 42 is powered from a battery 50 (power source) through a power source relay 51 (switching portion). On/off of the power source relay 51 is switched by hand on/off operation of an ignition switch 52 (operating portion). When the ignition switch 52 is turned on, the power source relay 51 is turned on and electricity is supplied to the range change control apparatus 42. When the ignition switch 52 is turned off, the power source relay 51 is shut down and the electricity supplied to the range change control apparatus 42 is stopped.

The rotational angle (rotational amount) of the motor 12 is converted to an operation amount of the range change mechanism 11 (a slide amount of the parking rod 19) via a rotational transmission system. The rotational transmission system may include the speed reducing mechanism 26, the output shaft 13, the detent lever 15, and the detect spring 23. A play may be generated between the members of the rotational transmission system. For example, a play (backlash) may be generated between gear wheels of the speed reducing mechanism 26. Further, it is necessary to provide a clearance for easily fitting a connecting portion of a rotational shaft of the motor 12 to an engaging hole of the output shaft 13. The connecting portion is provided at a distal end portion of the rotational shaft and a cross-section of the connecting portion is a noncircle-shape such as square-shape or D-shape.

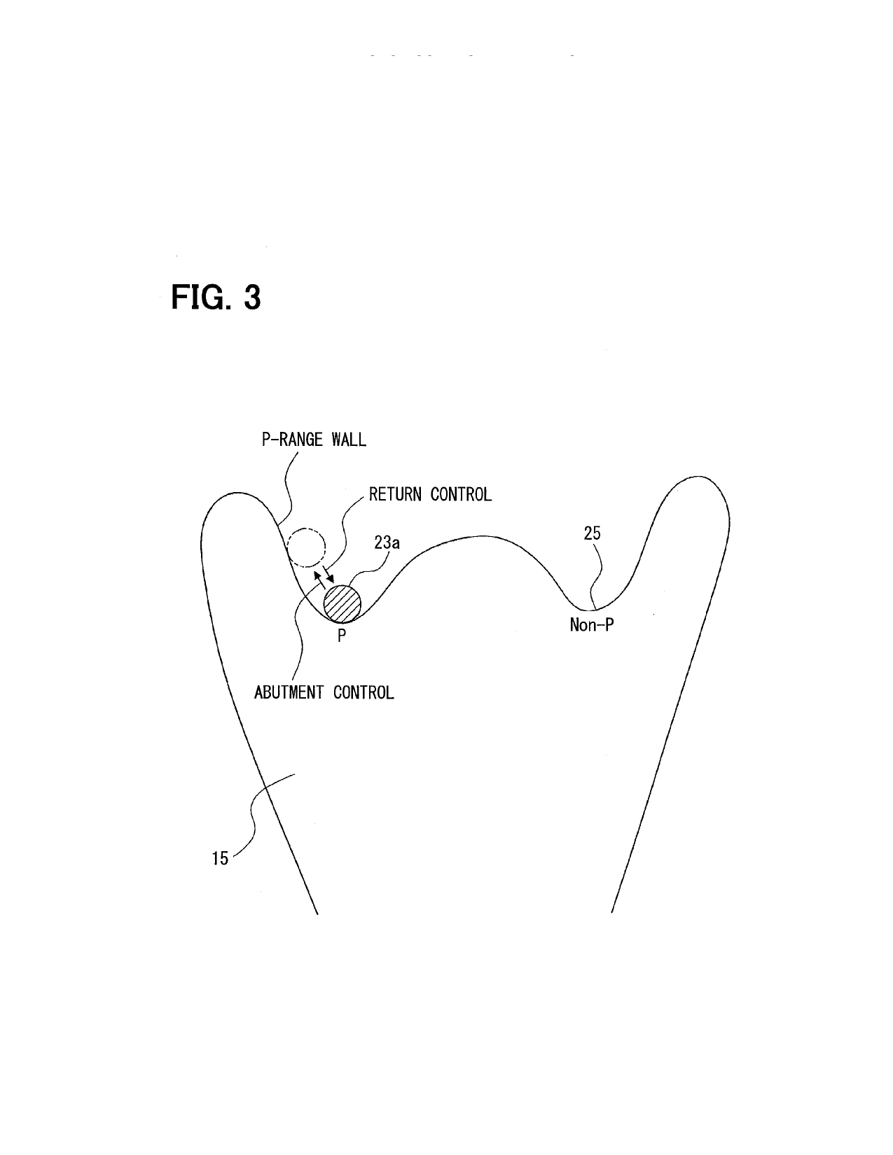

As shown in FIG. 3, when the engaging portion 23a is fitted into the P-range holding recess 24 or the Non-P-range holding recess 25, a space (play) is generated between the engaging portion 23a and the P-range holding recess 24 or the Non-P-range holding recess 25. In this case, even though the rotational amount of the motor is controlled with accuracy based on the encoder count value, an error corresponding to the space of rotational transmission system is generated in the operation amount of the range change mechanism 11, and thereby the operation amount of the range change mechanism 11 may not be controlled with accuracy.

According to the present embodiment, a correspondence relationship between the exciting phase of the motor 12 and the encoder count value is learned by an initial drive operation after energizing the range change control apparatus 42. The ECU 41 executes an abutment control in which the motor 12 is rotated until the engaging portion 23a is abutted against a side wall (P-range wall) of the P-range holding recess 24. As shown in FIG. 3, the P-range wall is located at a limit position of the P-range holding recess 24 of a moveable range of the engaging portion 23a. The encoder count value of the P-range wall position is sensed and learned as the encoder count value of a standard position. The rotational amount of the motor 12 is controlled based on the encoder count value of the standard position. In this case, the standard position is not limited to the P-range wall position. The standard position may be a position at a bottom of the P-range holding recess 24. In the initial drive operation, the edges of the A-phase signal and the edges of the B-phase signal are both counted. Then, the relationship between the encoder count value and the exciting phase (the rotational position of the rotor) at the end of the initial drive operation is learned, and a phase correction value with respect to the encoder count value is learned.

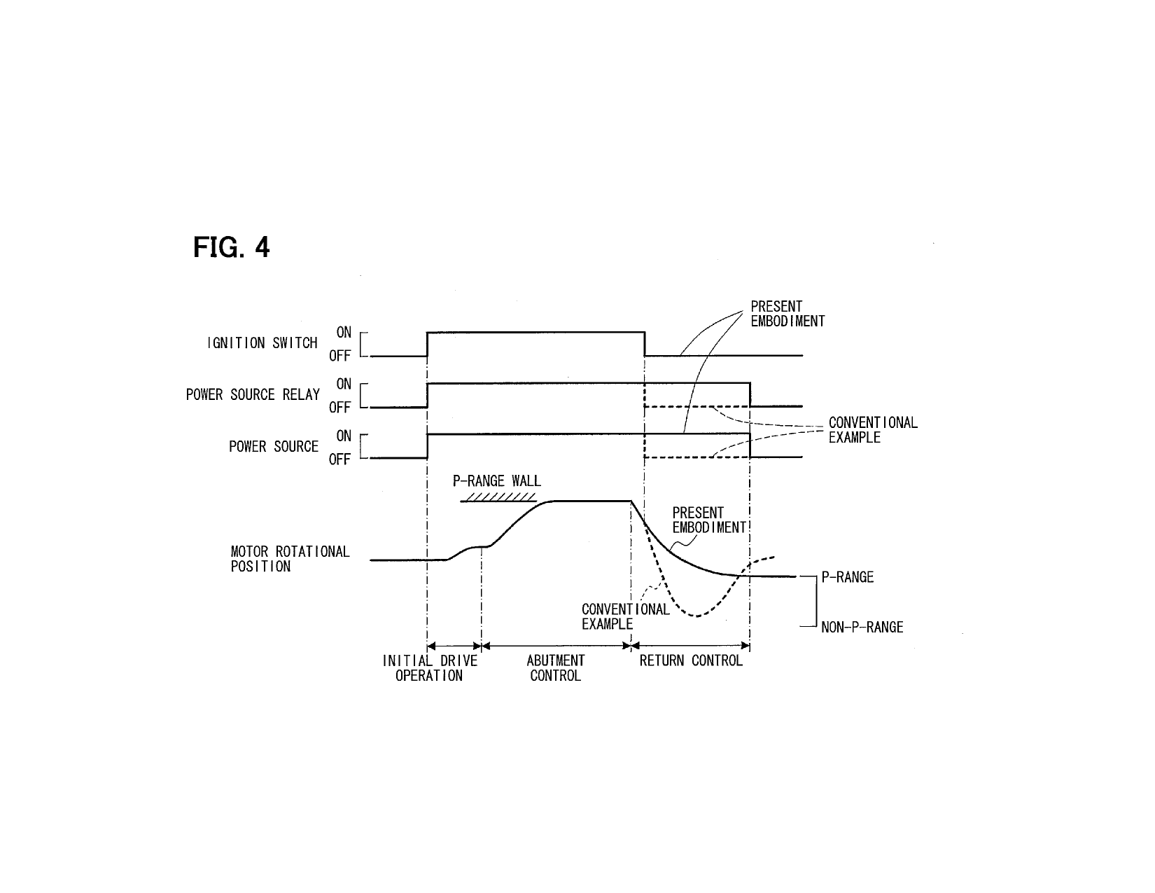

When the motor 12 is rotated in one direction by the abutment control after the initial drive operation, the detent spring 23, which is a relatively weak part of the rotational transmission system in stiffness, is bent and deformed by a torque of the motor 12, and thereby an elastic repulsion is generated. As shown in FIG. 4, when the motor 12 is stopped at the P-range wall, the motor 12 is returned by the elastic repulsion. Thus, it is likely that the shift range may change to Non-P-range without purpose by the elastic repulsion.

According to the present embodiment, a return control is operated so that the rotational position of the motor 12 is returned by a predetermined amount to cancel the deformation in the detent spring 23 by rotating the motor 12 in an opposite direction opposition from the one direction after executing the abutment control.

A conventional example will be described with reference to FIG. 4 in comparison with the present embodiment. Usually, the motor 12 is operated continuously from the time the abutment control is started to the time the return control is completed. Conventionally, when a driver turns the ignition switch 52 off in the abutment control or the return control, the power supply to the range change control apparatus 42 is shut down because the power source relay 51 is turned off as dotted lines shown in FIG. 4. In this case, the drive operation of the motor 12 is terminated so that the elastic repulsion may still exist during the abutment control or the return control. It is likely that the shift range may be non-intentionally changed to the Non-P-range by the elastic repulsion.

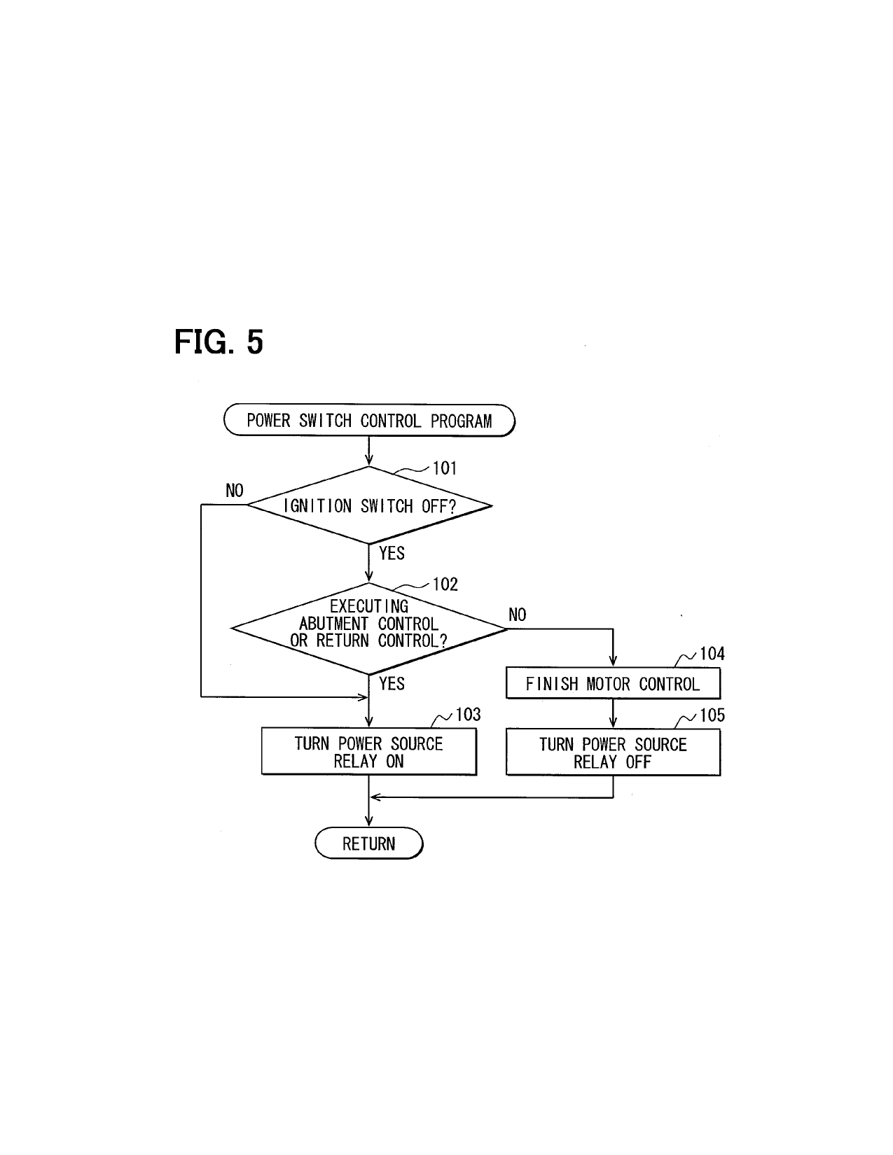

According to the present embodiment, when the ignition switch 52 is turned off in a time period from the time the abutment control is started to the time the return control is completed, a power switch control program shown in FIG. 5 is operated by the ECU 41 (control portion). Thus, the power source relay 51 is maintained to be turned on (ON-state) so that the power supply to the range change control apparatus 42 is continued to complete the return control. In this case, a predetermined return amount of the motor 12 by the return control is set to cancel the deformation of the detent spring 23 generated by the abutment control. In the present embodiment, the rotational position of the motor 12 is returned by the return control to the position of the P-range (bottom of the P-range holding recess 24) adjacent to a target position (P-range wall) of the abutment control. In this case, the bottom of the P-range holding recess 24 may correspond to one of a plurality of operating positions adjacent to the limit position. Thus, the motor 12 can be stopped while the motor 12 is certainly returned to the position of the P-range by the return control.

A procedure of the power switch control program will be described according to FIG. 5. The ECU 41 repeatedly executes the power switch control program as a control portion for a predetermined period during the power supply to the range change control apparatus 42.

At 101, the ECU 41 determines whether the ignition switch 52 is off. When the ECU 41 determines that the ignition switch 52 is on, the ECU 41 proceeds to 103. At 103, the ECU 41 maintains the power source relay 51 on so that the power supply to the range change control apparatus 42 is continued.

When the ECU 41 determines that the ignition switch 52 is off at 101, the ECU 41 proceeds to 102. At 102, the ECU 41 determines whether the ECU 41 is executing the abutment control or the return control, that is, the ECU 41 determines whether the ECU 41 is in the time period from the time the abutment control is started to the time the return control is completed. When the ECU 41 determines that the ECU 41 is executing the abutment control or the return control, the ECU 41 proceeds to 103, and continues the power supply until the return control is completed.

Then, when the return control is completed, the ECU 41 determines that the ECU 41 is not executing the abutment control or the return control (102: NO), the ECU 41 proceeds to 104. At 104, the ECU 41 terminates the motor control, that is, the ECU 41 breaks out of a loop of 101, 102, and 103. Then the ECU 41 proceeds to 105. At 105, the ECU 41 turns the power source relay 51 off so that the power supply to the range change control apparatus 42 is shut down. Then, the motor 12 is completely stopped.

According to the present embodiment, when the ignition switch 52 is turned off during the time period from the time the abutment control is started to the time the return control is completed, the ECU 41 maintains the power source relay 51 to the ON-state until the return control is completed so that the power supply to the range change control apparatus 42 is continued to complete the return control. Thus, the abutment control and the return control can be operated completely even though the ignition switch 52 is turned off in the abutment control or the return control. Therefore, the shift range can be prevented from changing to Non-P-range without purpose.

According to the present embodiment, the motor 12 can be stopped at the P-range position because the rotational position of the motor 12 is returned to the P-range position by the return control.

The return control is not limited to return the rotational position of the motor 12 to the P-range position. The return control may return the rotational position of the motor 12 by an amount to just cancel the deformation in the detent spring 23 generated by the abutment control. For example, the return control may return the rotational position of the motor 12 to the operation position adjacent to the limit position of a plurality of changeable operating positions of the range change mechanism 11.

The motor 12 also may be rotated to a side wall of the Non-P-range holding recess 25 (Non-P-range wall) opposite to the P-range wall according to the present embodiment.

The encoder 46 is not limited to the magnetic encoder. For example, an optical encoder or a brush encoder may be used in place of the magnetic encoder. Further, the encoder 46 may output a Z-phase signal for correction (index) in addition to the A-phase signal and the B-phase signal.

Furthermore, the motor 12 is not limited to the SR motor. That is, in place of the SR motor, it is possible to use other type of brushless synchronous motor, in which an exciting phase(s) is sequentially changed by sensing a rotational position of a rotor based on a count value of an output signal(s) of the encoder.

Furthermore, the present disclosure may be applied to a range change apparatus (control object), in which a range change valve and a manual valve of the automatic transmission 27 are changed synchronously with the rotational operation of the detent lever 15 to change the range to one of the multiple ranges, such as the parking range (P-range), the reverse range (R-range), the neutral range (N-range) and the drive range (D-range) and the like.

The present disclosure is not limited to the automatic transmission (AT, CVT, DCT), and may be applied to other range change device that changes the shift range. For example, the present disclosure may be applied to a range change device changing the shift range of the speed reducing mechanism for an electric vehicle.

Furthermore, the present disclosure is not limited to the range change apparatus and can be applied to other type position change apparatus, which use the brushless synchronous motor (e.g., the SR motor) as its drive source.

Such changes and modifications are to be understood as being within the scope of the present disclosure as defined by the appended claims.

What is claimed is:

1. A motor control apparatus that controls a motor which switches an operating position of a control object and that is powered from a power source through a switching portion which is turned on or off by an operating portion, the motor control apparatus comprising
a control portion executing a return control after an abutment control, the control portion executing the abutment control by rotating the motor in one direction until the control object is abutted against a limit position of a moveable range of the control object, the control portion executing the return control by rotating the motor in an opposite direction opposite from the one direction to return a rotational position of the motor by a predetermined amount, wherein
the control portion maintains the switching portion on until the return control is completed so as to continue powered from the power source, when the operating portion is operated to turn the switching portion off in a time period from when the abutment control is started to when the return control is completed.

2. The motor control apparatus according to claim 1, wherein
the motor switches the operating position of the control object among a plurality of positions, and
the control portion returns the rotational position of the motor to one of the plurality of positions adjacent to the limit position by the return control.

3. The motor control apparatus according to claim 1, wherein
the control object is a range change mechanism that changes a shift range.
